(19) United States
(12) Patent Application Publication
(10) Pub. No.: US 2021/0278680 A1
(43) Pub. Date: Sep. 9, 2021

(54) METHOD TO VARY THE DIAMETER OF A LASER BEAM

(71) Applicant: BAE SYSTEMS Information and Electronic Systems Integration Inc., Nashua, NH (US)

(72) Inventor: Philip R. Staver, Wilton, NH (US)

(73) Assignee: BAE SYSTEMS Information and Electronic Systems Integration Inc., Nashua, NH (US)

(21) Appl. No.: 16/808,509

(22) Filed: Mar. 4, 2020

(51) Int. Cl. G02B 27/09; G02B 9/60; H01S 3/00

(52) U.S. Cl. CPC G02B 27/0966; H01S 3/005; G02B 27/0961; G02B 9/60

(57) ABSTRACT

Techniques, systems, architectures, and methods for modulating the focal spot and/or divergence of a laser beam comprising the use of a collimated light source, a lens assembly disposed within an optical path corresponding to light emanating from the collimated light source wherein the lens assembly comprises two pairs of cross cylinder lenses having equal and opposite focal powers oriented with their neutral axes positioned orthogonally to each other; and a focusing objective lens assembly disposed within the optical path following the lens assembly, wherein each of the two pairs of cross cylinder lenses are configured for rotation about an axis defined by the point at which light from the collimated light source impinges on each of them.

### FIELD OF THE DISCLOSURE

The following disclosure relates generally to optical systems and, more specifically, methods and systems for varying the diameter of a laser beam focal spot.

### BACKGROUND

A laser is a common optical source having a wide array of applications. Exemplary applications include laser hole-drilling, laser marking, laser counter measures, laser targeting and tracking (in military defense applications), bar code scanning, laser eye surgery, laser processing of materials, and laser pumping of other laser sources. As is the case in most applications involving the use of a laser or lasers, all of the aforementioned applications require precise control over the diameter of the laser beam and focal spot 102. For example, when lasers are used for hole drilling, the laser power is used to melt, evaporate, or ablate the material, creating a hole through it. In this example, the diameter of the laser-drilled hole could be changed by changing the diameter of the focal spot 102.

The most common method used to change (or control) the spot size 102 of a laser beam, which is herein referred to as method 1, is changing the final lens that focuses the collimated light of the laser beam into a small focal spot 102. The mathematical relationship that defines this spot diameter is summarized by Equation (1), shown below.

$${D}_{focus} = \frac{4}{π} \cdot \frac{{M}^{2} λ}{{D}_{l a s e r}} \cdot f \qquad Equation ( 1 )$$

In this equation, D_{focus} is the diameter of the focused laser spot 102, M² is the beam quality of the laser source, λ is the wavelength, Dₗₐₛₑᵣ is the diameter of the laser source, as incident on the lens, and f is the effective focal length of the focusing lens.

The main problem with method 1 is that the value of D_{focus} cannot be adjusted continuously or easily; the lens has to be removed and then replaced with a different lens to change the value of D_{focus}. At a minimum, this requires the entire application or process to be shut down while this lens is changed. In some cases, this may also necessitate a complete system alignment. Furthermore, when changing the spot size using method 1, the position of focal region 100 or the position of the lens must be changed.

Another method, which is herein referred to as method 2, involves replacing the fixed focal length lens represented in Equation (1) with a variable focal length lens, i.e. a zoom lens. This configuration allows for adjustment of the value of f in Equation (1) without lens replacement, however, it is also a relatively complex arrangement that is expensive to produce, limits the speed at which the spot size 102 can be changed, and offers only a limited range of adjustment.

A third method, which is herein referred to as Method 3, employs a zoom lens in an afocal telescope placed before the fixed lens. This method varies the spot size at the focus by varying the value of Dₗₐₛₑᵣ in Equation (1) while maintaining the location of focal spot 102 and is described by Milne, in US Patent US2011/0127697 A1. This method is even more complex than Method 2 and suffers from many of its shortcomings.

Furthermore, using either method 2 or 3, the lenses used to provide the variable focal length must be translated along a mutual axis to “zoom” the focal length of the focusing lens (method 2) or the afocal telescope (method 3), which is typically a relatively slow process and limits the speed at which the spot size 102 can be changed.

What is needed, therefore, are systems and methods for changing the diameter of a focused laser spot 102 and/or divergence of a laser beam that allow for fast, continuous adjustment over a large dynamic range while being highly mechanically-stable.

### SUMMARY

In embodiments, several optical elements arranged in a specific configuration that includes two pairs of crossed-cylinder lenses placed before a focusing objective lens provides the ability to change the diameter of a laser beam quickly and continuously over a large dynamic range while being mechanically simpler and cheaper to produce, compared to existing solutions.

The systems and methods provided herein may also be used to vary the divergence of a laser beam directed at a distant target. In this application, it maintains the same benefits previously stated with the added benefit of being mechanically stable in regards to pointing precision.

The features and advantages described herein are not all-inclusive and, in particular, many additional features and advantages will be apparent to one of ordinary skill in the art in view of the drawings, specification, and claims. Moreover, it should be noted that the language used in the specification has been selected principally for readability and instructional purposes and not to limit the scope of the inventive subject matter.

### BRIEF DESCRIPTION OF THE DRAWINGS

FIG. 1 is a schematic showing a lens arrangement and beam shape as it passes through the lens arrangement and impinges on a surface, in accordance with embodiments of the present disclosure;

FIG. 2A is a schematic showing a neutral lens arrangement, in accordance with embodiments of the present disclosure;

FIG. 2B is a schematic showing a rolled lens arrangement, in accordance with embodiments of the present disclosure;

FIG. 3A is a schematic showing a neutral lens arrangement alongside a depiction of the beam focal spot produced by that configuration, in accordance with embodiments of the present disclosure;

FIG. 3B is a schematic showing a slightly-rolled lens arrangement alongside a depiction of the beam focal spot produced by that configuration, in accordance with embodiments of the present disclosure;

FIG. 3C is a schematic showing a significantly-rolled lens arrangement alongside a depiction of the beam focal spot produced by that configuration, in accordance with embodiments of the present disclosure;

FIG. 4 is a chart depicting the evolution of the spot size (quantified as RMS Radius of Spot) through a region near the nominal focal plane of the Focusing Objective Lens (specified in FIG. 1) for three different cylinder rotation values, the solid curve corresponding to a cylinder rotation of 0 degrees, the dashed curve corresponding to a cylinder rotation of +/−5 degrees, and the dash-dot curve corresponding to a cylinder rotation value of +/−10 degrees;

FIG. 5 is a chart that shows the diameter of the focal spot versus the rotation of the cross-cylinder lenses for two different configurations of cross-cylinder lenses; and

FIG. 6 is a chart comparing rotation of the cross-cylinder pair with the diameter of the focal spot produced thereby.

These and other features of the present embodiments will be understood better by reading the following detailed description, taken together with the figures herein described. The accompanying drawings are not intended to be drawn to scale. For purposes of clarity, not every component may be labeled in every drawing.

### DETAILED DESCRIPTION

The present disclosure teaches varying the diameter of a focal spot 102 using several optical elements arranged in a specific configuration that includes two pairs of crossed-cylinder lenses 106/108 placed before a focusing objective lens 104, allowing for quick and continuous changes over a large dynamic range while being mechanically simpler and cheaper to produce, compared to existing solutions.

Regarding terminology used herein, cross-cylinder lenses, which may also be referred to as Jackson crossed-cylinder lenses or crossed-cylinder lenses, should be understood to refer to lens assemblies comprising two cylinder lenses having equal and opposite focal powers oriented with their neutral axes positioned orthogonally to each other. The “cylinder” shape of the lens refers to the shape of the lens surface that is exposed to an optical beam; this is the surface of the lens that the beam propagates through. The perimeter of the lens, as shown in the Figures, is square due to this being a convenient shape for mounting the lenses. The shape of the perimeter of the lens, however, could be of any shape as it does not impact the performance of this device.

Notably, cross-cylinder lenses are conventional devices and are commonly used in the ophthalmic industry in instruments that are used for measuring the refractive errors of human eyes. In that industry, however, they are not used in the ways described herein.

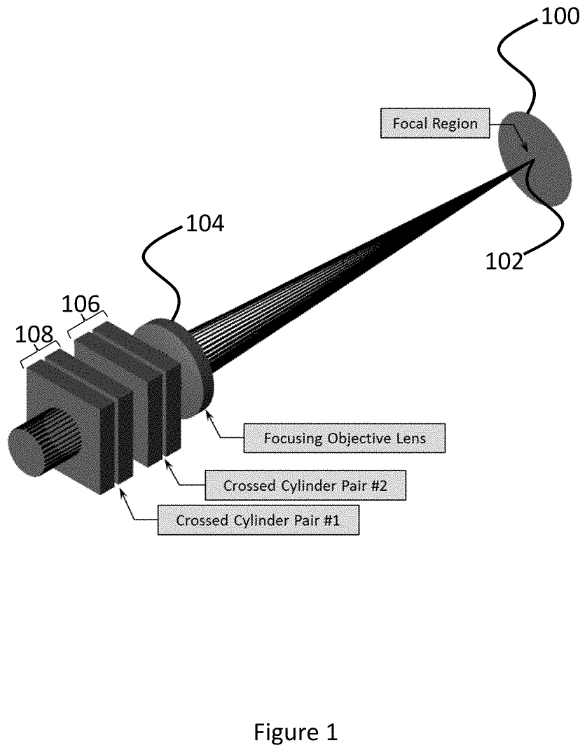

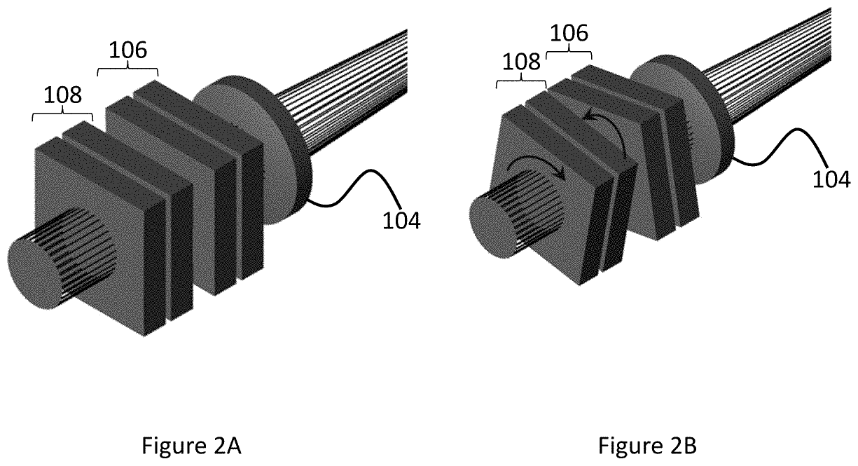

An embodiment of the present disclosure is depicted in FIG. 1. The embodiment depicted in FIG. 1 comprises two pairs of cross-cylinder lenses 106/108 placed before a focusing objective lens 104, which may also be referred to as simply a focusing lens 104. To adjust the diameter of the focal spot 102 (the region of minimum spot size) produced by such a configuration, the two crossed cylinder lenses 106/108 are rotated in equal and opposite directions, as depicted in FIG. 2. The result of this action is to introduce an equal and opposite amount of astigmatism to the orthogonal axes. This preserves the location of the focal spot 102 while allowing for continuous adjustment of the diameter thereof.

In embodiments, only one of the pairs of crossed cylinder lenses 106/108 is rotated. In embodiments, to achieve the same rate of change as embodiments where the two crossed cylinder lenses 106/108 are rotated in equal and opposite directions, as depicted in FIG. 2, the one of the pairs of crossed cylinder lenses 106/108 is rotated twice as fast as in counter-rotating embodiments.

The following table, Table 1, defines the optical configuration of the exemplary embodiment of FIG. 1. The configuration that is described in Table 1 is not the only possible configuration; other configurations are possible by changing the value of the Effective Focal Length (EFL) of the cross cylinder lenses 106/108 and by varying the value of the EFL of the focusing objective lens 104. The choice of EFL of the focusing objective lens 104 determines the minimum focus diameter achievable by the embodiment. The choice of the EFL of the crossed-cylinder lenses 106/108 determines the range of focus diameter adjustment and, hence, the maximum achievable focus diameter.

TABLE 1
Optical configuration of embodiments of the present disclosure
Wavelength = 1.064 microns
Beam Diameter = 10.0 mm

| | | | | Thick- | | |
|---|---|---|---|---|---|---|
| | EFL X | EFL Y | | ness | Width | |
| Item | (meters) | (meters) | Material | (mm) | (mm) | Shape |
| Cylinder | INF | 10.00 | Infrasil | 4.00 | 20 | Rectangular |
| Lens 1 | | | | | | |
| Cylinder | −10.00 | INF | Infrasil | 4.00 | 20 | Rectangular |
| Lens 2 | | | | | | |
| Cylinder | INF | 10.00 | Infrasil | 4.00 | 20 | Rectangular |
| Lens 3 | | | | | | |
| Cylinder | −10.00 | INF | Infrasil | 4.00 | 20 | Rectangular |
| Lens 4 | | | | | | |
| Focusing | 0.1 | 0.1 | Infrasil | 4.00 | 20 | Round |
| Objective | | | | | | |

While Infrasil is the material used in the embodiments described in Table 1, other materials could also be used, with the specific material choice being dependent on the wavelength of light used in a particular application. For instance, in a long-wave infrared application, Germanium, Silicon, ZnSe, Cleartran, and other materials are suitable. In visible light applications, materials like BK7, F2, and similar would be suitable. These materials are merely exemplary; many others could be used, as would be known to one of ordinary skill in the art.

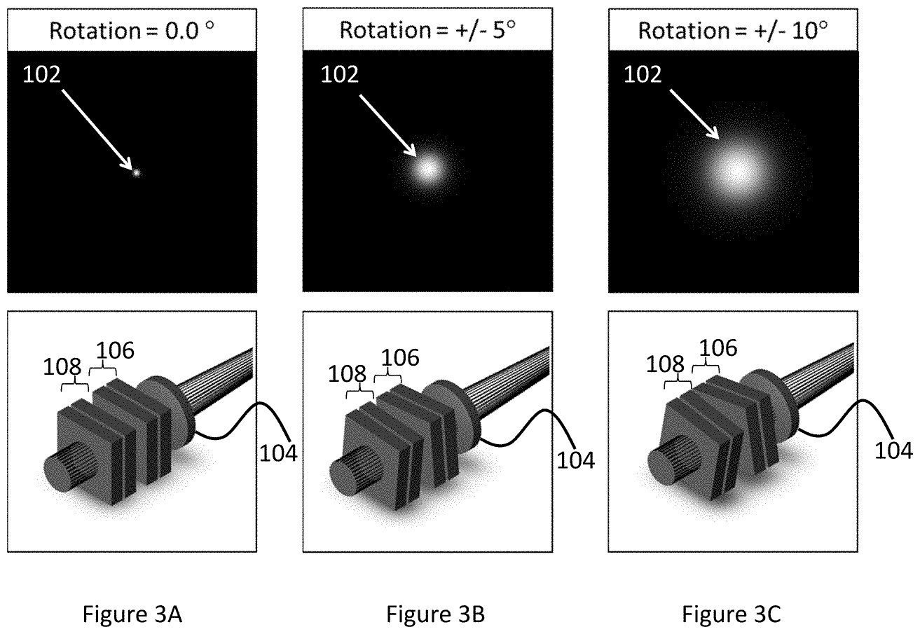

A computer simulation of the effect of rotating the two cross-cylinder pairs 106/108 is summarized in FIGS. 3A, 3B, and 3C. FIGS. 3A, 3B, and 3C show that the focal spot 102 size can be varied substantially with the configuration described in Table 1.

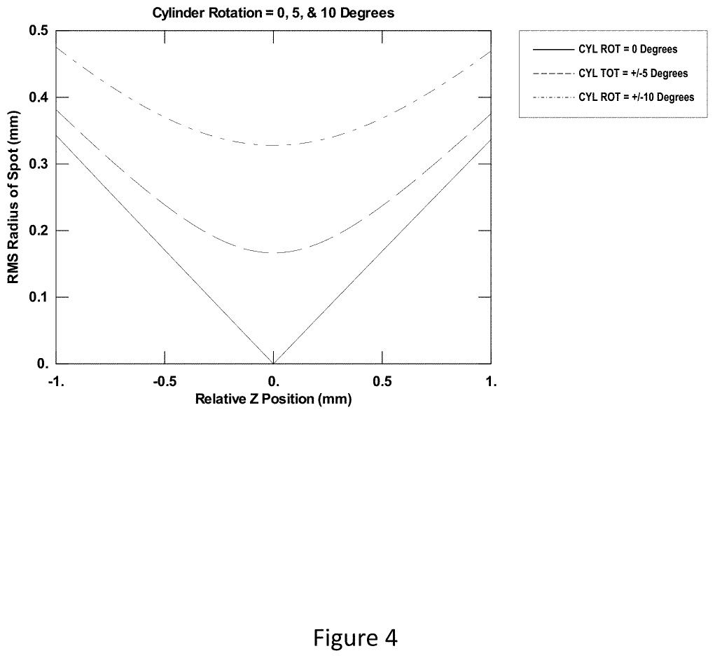

The size of the beam converging on the focal spot 102 is summarized in FIG. 4. In FIG. 4, the size of the beam is expressed as a RMS radius for three different orientations of the crossed-cylinder pairs 106/108, +/−0.0 degrees, +/−5.0 degrees, and +/−10.0 degrees. FIG. 4 shows that, in all 3 cases, the location of the focal spot 102 has not changed while the size of the focal spot 102 has changed considerably.

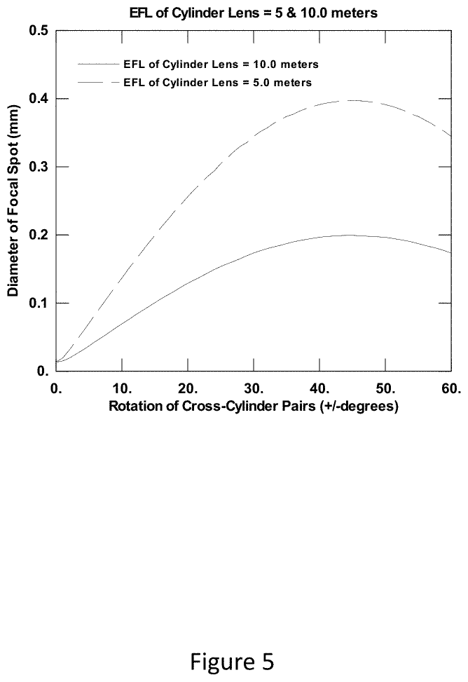

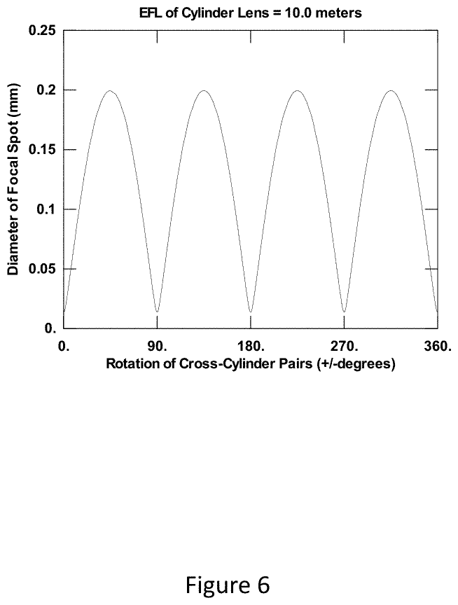

FIG. 5 summarizes the effect on the focal spot 102 diameter as the two crossed-cylinder pairs 106/108 are rotated. The upper figure depicts two different embodiments of the present disclosure. The first embodiment uses crossed-cylinder lenses 106/108 having an effective focal length of +/−10 meters (solid curve), and the second uses crossed-cylinder lenses 106/108 having an effective focal length of +/−5 meters (dashed curve). FIG. 5 (top) shows that the range of adjustment can be changed by choosing a different value for the effective focal length of the cross cylinder pairs 106/108.

If we define the Modulation Factor of a given lens configuration to be the quantity defined in Equation (2), as follows:

$$Modulation Factor = \frac{Maximum focal diameter}{Minimum focal diameter} , \qquad Equation ( 2 )$$

FIG. 5 shows that large values of the Modulation Factor can be achieved using embodiments of the present disclosure. Table 2 summarizes the performance characteristics of four different choices of the value of the EFL of the cylinder power of the crossed-cylinder lenses 106/108. The Modulation Factor of embodiments can be chosen to be virtually any value by choosing the value of the EFL of the crossed-cylinder pairs 106/108. As can be seen, modulation factors greater than 50× are easily achievable and modulation factors as large as 100:1 are possible.

TABLE 2
Summary of the performance of different choices of the value of
the EFL of the cylinder power of the cross-cylinder lenses.

| EFL of Cross- | Minimum | Maximum | |
|---|---|---|---|
| Cylinder Lens | Focus Diameter | Focus Diameter | Modulation |
| (+/−meters) | (mm) | (mm) | Factor |
| 20 | 0.0139 | 0.101 | 7.3 X |
| 10 | 0.0139 | 0.199 | 14.4 X |
| 5 | 0.0139 | 0.397 | 28.7 X |
| 2.5 | 0.0139 | 0.791 | 56.7 X |

A method of computing the effective diameter of the focused spot size 102, D_{effective}, in accordance with embodiments of the present disclosure follows. More specifically, it is well known in the optics field of study that the peak axial intensity of a Gaussian laser beam profile, Ipeak, is related to the total beam power, P_{Total}, and focal spot diameter 102, D₀, by the relationship defined in Equation (3), shown below.

$${I}_{p e a k} = \frac{8}{π} \cdot \frac{{P}_{Total}}{{D}_{0}^{2}} \qquad Equation ( 3 )$$

This relation can be inverted to compute an effective diameter from any intensity profile, computed at any point along its propagation path. If Equation (3) is solved for D₀, an effective beam diameter can be computed from the diffraction calculations as:

$${D}_{effective} = \sqrt{\frac{8}{π} \cdot \frac{{P}_{Total}}{{I}_{p k}}} \qquad Equation ( 4 )$$

Embodiments of the present disclosure can also be used to adjust the divergence of a laser beam in the so called “far-field.” This is the region of propagation in which the size of the laser beam grows linearly with propagation distance. Therefore, the teachings of this disclosure can be used to adjust the divergence of a transmitted laser by a large factor (as summarized in Table 2). If this laser is being used as an illumination device, it could keep an illuminated target under a constant level of illumination as the target moves over a very larger range of distance. For example, when the target is near, the crossed-cylinder lenses 106/108 would be adjusted to give a very large divergence (reducing the illumination on the target). As the target moves away, the crossed-cylinder lenses 106/108 would be adjusted to reduce the beam divergence (increasing the illumination on the target).

Furthermore, there are applications where it is desirable to periodically modulate the diameter of the focal spot 102 or modulate the divergence of a transmitted laser beam. Since the diameter of the focal spot 102 size for embodiments of the present disclosure is periodic, with a rotational period of 90 degrees, embodiments of the present disclosure inherently provide the ability to continuously and smoothly modulate a laser beam.

The foregoing description of the embodiments of the present disclosure has been presented for the purposes of illustration and description. It is not intended to be exhaustive or to limit the present disclosure to the precise form disclosed. Many modifications and variations are possible in light of this disclosure. It is intended that the scope of the present disclosure be limited not by this detailed description, but rather by the claims appended hereto.

A number of implementations have been described. Nevertheless, it will be understood that various modifications may be made without departing from the scope of the disclosure. Although operations are depicted in the drawings in a particular order, this should not be understood as requiring that such operations be performed in the particular order shown or in sequential order, or that all illustrated operations be performed, to achieve desirable results.

What is claimed is:

1. An optical system for modulating the focal spot and/or divergence of a laser beam, the system comprising:
a lens assembly comprising a pair of cross cylinder lenses having equal and opposite focal powers oriented with their neutral axes positioned orthogonally to each other; and
a focusing objective lens assembly disposed within an optical path defined by the lens assembly,
wherein at least one of the pair of cross cylinder lenses is configured for rotation about an axis defined by the point at which the optical path impinges on each of them.

2. The system of claim 1, further comprising a collimated light source configured to send collimated light down the optical path.

3. The system of claim 1, wherein the cross cylinder lenses are square in shape.

4. The system of claim 1, wherein the cross cylinder lenses are round in shape.

5. The system of claim 1, wherein the cross cylinder lenses are rectangular in shape.

6. The system of claim 1, wherein the cross cylinder lenses are Jackson cross-cylinder lenses.

7. The system of claim 1, wherein each of the pairs of cross cylinder lenses is configured solely for equal and opposite rotation, relative to the other.

8. The system of claim 1, wherein the focusing objective lens assembly is a single focusing objective lens.

9. The system of claim 8, wherein the cross cylinder lenses and the focusing objective lens are made of Infrasil.

10. The system of claim 9, wherein the cross cylinder lenses and the focusing objective lens are 4 mm thick and 20 mm wide.

11. The system of claim 10, wherein the cross cylinder lenses are rectangular and the focusing objective lens is round.

12. The system of claim 11, wherein the pair of cross cylinder lenses comprises a first pair of cylinder lenses and a second pair of cylinder lenses, the first pair of cylinder lenses comprising a first cylinder lens having an effective focal length of infinity in an X-axis and 10.00 in a Y-axis and a second cylinder lens having an effective focal length of −10.00 in the X-axis and infinity in the Y-axis, and the second pair of cylinder lenses comprising a third cylinder lens having an effective focal length of infinity in the X-axis and 10.00 in the Y-axis and a fourth cylinder lens having an effective focal length of −10.00 in the X-axis and infinity in the Y-axis.

13. The system of claim 12 wherein the focusing objective lens has an effective focal length of 0.1 in the X-axis and 0.1 in the Y-axis.

14. A method of modulating the focal spot and/or divergence of a laser beam, the method comprising:
providing an optical system comprising:
a collimated light source;
a lens assembly disposed within an optical path corresponding to light emanating from said collimated light source wherein the lens assembly comprises a pair of cross cylinder lenses having equal and opposite focal powers oriented with their neutral axes positioned orthogonally to each other; and
a focusing objective lens disposed within the optical path following the lens assembly,
wherein at least one of the pair of cross cylinder lenses is configured for rotation about an axis defined by the point at which light from the collimated light source impinges on it,
directing an output of the collimated light source through a central portion of the lens assembly corresponding to the optical path; and
rotating at least one of the pair of cross cylinder lenses about an axis corresponding to the optical path.

15. The method of claim 14, wherein the collimated light source is a laser.

16. The method of claim 14, wherein the cross cylinder lenses are rectangular and the focusing objective lens is round.

17. The method of claim 14 wherein the cross cylinder lenses are Jackson cross-cylinder lenses.

18. The method of claim 14, wherein the focusing objective lens assembly is a single focusing objective lens.

19. The method of claim 14, wherein the cross cylinder lenses and the focusing objective lens are made of Infrasil.

20. An optical system for modulating the focal spot and/or divergence of a laser beam, the system comprising:
a collimated light source;
a lens assembly disposed within an optical path corresponding to light emanating from said collimated light source wherein the lens assembly comprises a pair of cross cylinder lenses having equal and opposite focal powers oriented with their neutral axes positioned orthogonally to each other; and
a focusing objective lens assembly disposed within the optical path following the lens assembly,
wherein at least one of the pair of cross cylinder lenses is configured for rotation about an axis defined by the point at which light from the collimated light source impinges on it,
wherein at least one of the pairs of cross cylinder lenses is configured for rotation, relative to the other, and
wherein the cross cylinder lenses and the focusing objective lens are made of Infrasil.
